(19) United States
(12) Patent Application Publication
(10) Pub. No.: US 2019/0136676 A1
(43) Pub. Date: May 9, 2019

(54) SYSTEM FOR INJECTING NITROGEN GAS IN A WELL

(71) Applicant: JOHN W. ROCKEFELLER, EL DORADO HILLS, CA (US)

(72) Inventor: JOHN W. ROCKEFELLER, EL DORADO HILLS, CA (US)

(21) Appl. No.: 15/808,834

(22) Filed: Nov. 9, 2017

(51) Int. Cl. E21B 43/24; E21B 43/25; B01D 53/02

(52) U.S. Cl. CPC E21B 43/24; E21B 43/255; B01D 2257/80; B01D 2253/116; B01D 2257/102; B01D 53/02

(57) ABSTRACT

A system and method for the recovery of hydrocarbons from a subterranean formation is provided. The system includes a molecular sieve configured to separate nitrogen gas from ambient air. The nitrogen gas is passed through a compressor to increase the pressure of the nitrogen gas. The temperature is elevated by passing the gas through a heat exchanger wherein the gas does not mix with the heated exhaust generated through a combustion process. An electronic controller is provided to monitor and regulate the components in the system and is in communication with the nitrogen gas to monitor and regulate the temperature, pressure, and flow rate of the nitrogen gas. The method includes injecting the gas into the well for removal of hydrocarbons from the subterranean formation.

### BACKGROUND

### 1. Field of the Invention

The present application relates to a mechanical system and method used to inject a nitrogen gas into hydrocarbon producing subterranean formations, for example in the recovery of heavy oil.

### 2. Description of Related Art

Grades of oil are generally separated into classes according to viscosity, density, and sulfur content. The higher the viscosity and density of the oil, the more difficult to produce the oil from reservoirs to the surface. In particular, extra heavy oil and bitumen require production enhancement techniques for production. In the following description, the generic term “oil” may be used in reference to extra heavy oil and bitumen, but also applies to less viscous grades of oil.

A large portion of the world's potential oil reserves are in the form of extra heavy oil and bitumen. Various enhanced oil recovery processes are used to improve recovery of oil and other formation fluids from subterranean formations. Enhanced oil recovery processes include chemical injection, gas injection, and thermal recovery. Thermal recovery techniques or solvent based techniques result in a recovery efficiency in the range of between 20 and 25%. The most common thermal technique is steam injection in which heat enthalpy from the steam is transferred to the oil by condensation. The heating reduces the viscosity of the oil to allow gravity drainage and collection. Injection may be achieved by the well known cyclic steam simulation (CSS) and Steam Assisted Gravity Drainage (SAGD).

The costs and environmental impact of recovering the extra heavy oil and bitumen is an ongoing concern. Often fuel is burned to heat a water for the introduction of steam into the well. Additionally, exhaust gas from the burned fuel is also introduced into the well thereby having some environmental concerns. For purposes of illustration, steam generators require significant amounts of fuel to produce sufficient amounts of steam to stimulate production. The ratio of steam to oil produced (“steam on oil ratio” or SOR) using current techniques ranges from 1.4 to 4. In other words, 1.4 to 4 gallons of water must be evaporated into steam for each gallon of oil produced from the reservoir. In addition to the fuel consumed, much of the water is lost to the reservoir. What water returns to the surface with the produced oil must be treated to remove contaminants, such as heavy metals and sulfur. The treatment of water further adds to the cost of production.

Greenhouse gas emissions from steam generation are of concern. Some steps have been taken to try to capture harmful gases as a result but are still not as efficient as they need to be. For example, approximately 8,000 to 15,000 tons of carbon dioxide (CO2) can be generated daily to produce injection steam and produce 100,000 barrels of oil per day (BOPD) of bitumen. A simpler and more environmentally friendly solution is needed in order to reduce CO2 and other greenhouse gas emissions from extra heavy oil and bitumen production.

Vapor extraction is another technique for enhancing production of extra heavy oil and bitumen. The vapor extraction process involves injecting a gaseous hydrocarbon solvent into the reservoir where it dissolves into the oil, thereby reducing viscosity and allowing drainage into a lower horizontal well for extraction. Typical hydrocarbon solvents include propane, butane, or CO2 with a carrier gas. Currently, the vapor extraction alone, without also heating the reservoir, produces small improvements in oil recovery. The hydrocarbon solvents are expensive and a large percentage is lost in the reservoir during production.

Although strides have been made to improve systems and methods of extracting heavy oil and bitumen from subterranean formations, shortcomings remain. A new system is needed that does not introduce exhaust gas or steam into the well.

### SUMMARY OF THE INVENTION

An object of the present application is to provide a system for the injection of a nitrogen gas into a well for the capturing of hydrocarbons from subterranean formations. These hydrocarbons are typically thick and difficult to remove, such as heavy oil and bitumen. The system of the present application is configured to use a molecular sieve to separate nitrogen from the ambient air. The nitrogen gas is then heated to a set temperature and compressed to increase pressure. This gas is then introduced into the well to assist in the recovery of hydrocarbons.

It is an object of the present application to elevate the temperature and pressure of the gas in the system in accordance with conditions within the well. The combustion chamber design is unique due to the elevated volume and pressure of the gas. Pressures are set to be around the range of 2500 psi to 3500 psi. The pressure range is influenced by the number of perforations and number of feet perforated in the subterranean formation. Volumes of gas are seen in the region of 20,000 CFM to 30,000 CFM. The volume and pressure is controlled via a variable speed drive compressor. A heat exchanger is used to permit thermal transfer between a combustion process and the nitrogen gas in the system. The heat exchanger is configure to prevent the cross mixing of exhaust byproducts with that of the nitrogen gas to ensure no contamination occurs.

It is also an object of the present application so regulate the temperature, pressure, and flow rates of the gas into the well. This may be done in real time with one or more sensors located throughout the system. The sensors communicate through an electronic controller for processing.

The more important features of the system have thus been outlined in order that the more detailed description that follows may be better understood and to ensure that the present contribution to the art is appreciated. Additional features of the system will be described hereinafter and will form the subject matter of the claims that follow.

Many objects of the present system will appear from the following description and appended claims, reference being made to the accompanying drawings forming a part of this specification wherein like reference characters designate corresponding parts in the several views.

Before explaining at least one embodiment of the system in detail, it is to be understood that the system is not limited in its application to the details of construction and the arrangements of the components set forth in the following description or illustrated in the drawings. The system is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present system. It is important, therefore, that the claims be regarded as including such equivalent constructions insofar as they do not depart from the spirit and scope of the present system.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a chart of a system for injecting gas into wells according to an embodiment of the present application.

FIG. 2 is an exemplary schematic of an electronic controller used in the system of FIG. 1.

FIG. 3 is a chart of the method of injecting gas into wells according to the system of FIG. 1.

While the system and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the systems are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the system described herein may be oriented in any desired direction.

The system and method in accordance with the present application overcomes one or more of the above-discussed problems commonly associated with traditional methods and systems of extracting heavy oil and bitumen. In particular, the system of the present application is configured to generate a volume of nitrogen gas from the ambient air and subject it to elevated temperature and pressure prior to injecting it into a well that is in communication with a subterranean formation. The system is configured to inject nitrogen gas and avoid the mixture of the gas with exhaust generated from a combustion process used to induce heat. These and other unique features of the system are discussed below and illustrated in the accompanying drawings.

The system and method will be understood, both as to its structure and operation, from the accompanying drawings, taken in conjunction with the accompanying description. Several embodiments of the system may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The system and method of the present application is illustrated in the associated drawings. The system includes a molecular sieve configured to separate nitrogen gas from ambient air. A compressor is receives the nitrogen gas from the sieve and pressurized it to a set pressure. A heat exchanger is used to transfer heat energy to the nitrogen gas. The heat is produced through a combustion process. The heat exchanger is arranged to permit the transfer of heat energy from the combustion exhaust to the nitrogen gas without mixture of the gas with the exhaust. An electronic controller is used to monitor and regulate operation of the system as a whole and in particular affect the temperature, pressure and flow rate of the nitrogen gas. Additional features and functions of the system are illustrated and discussed below.

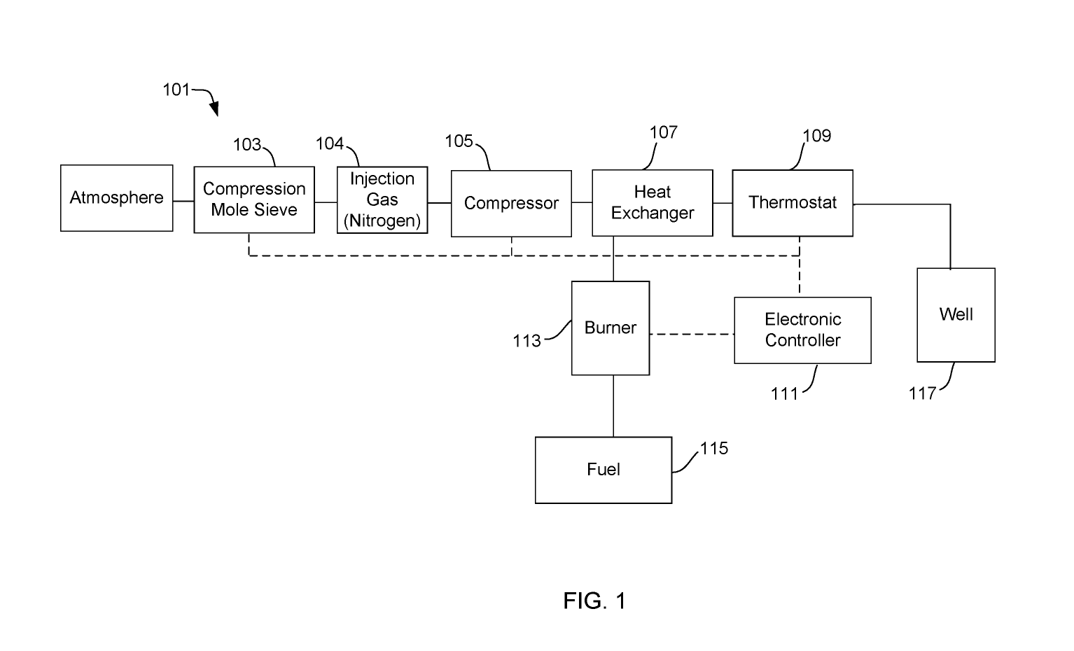

Referring now to the drawings wherein like reference characters identify corresponding or similar elements in form and function throughout the several views. FIG. 1 illustrates a chart of the system of the present application used for producing and subsequently injecting nitrogen gas into a well. System 101 includes a sieve 103, a compressor 105, a heat exchanger 107, a temperature sensor (thermostat) 109, and an electronic controller 111. A burner 113 for generating heat along with a fuel source 115 is also included.

System 101 captures air from the environment and separates out nitrogen gas for injection in well 117. The gas is passed through the one or more components described above to reach a desired temperature, pressure, and flow rate. Well 117 is in direct communication with a subterranean formation below the surface of the earth. Well 117 may be either a vertical well or a horizontal well for example. It is understood that a horizontal well will have significantly more exposure to the producing zone of the formation than a vertical well in the same formation. For example, a 1400 foot lateral in a 50 foot zone will have 28 times the exposure to the formation when compared to a vertical well in that same zone. Injection of the nitrogen gas at specific temperatures, pressures, and flow rates are set at particular levels dependent upon well and formation conditions. Injection of the nitrogen gas helps interact with heavy oil and bitumen in the formation to allow for the withdrawal of the hydrocarbons.

Molecular sieve 103 pulls air from the ambient environment and passes it through one or more filters with particularly sized pore diameters. The air may be forced into/through sieve 103 through one or more pumps or compressors. Sieve 103 is configured to separate out the nitrogen found in the air from the other elements to form injection gas 104. Sieve 103 also helps to pull the moisture out from the air as well, allowing the injection gas to be “dry”. It is understood that the injected gas is not composed of 100% nitrogen but will in fact also include some other minor amounts of various gas elements. For purposes here, reference to nitrogen gas will also include the small amounts of other elements and will hereinafter be referred to as injection gas 104.

The injection gas 104 is passed to compressor 105 from sieve 103. Compressor 105 compresses the injection gas to a predetermined level in accordance with well and formation conditions. This can be done through one or more compression stages and via one or more compressors. Ideally, compressor 105 is a variable speed compressor to permit the selective adjustment of both the volume and pressure of injection gas 104. The ability to adjust the volume and pressure levels of the injection gas is important as conditions with each well and formation are different and subject to change over time. An exemplary range of operation for compressor 105 is pressurizing the injection gas to a range of 2500 psi to 3500 psi. Other pressure levels are conceivable. An exemplary range of volume for injection gas 104 is a flow rate of 20,000 CFM to 30,000 CFM. These ranges are not meant to be limiting.

The injection gas is passed through heat exchanger 107 which is configured to permit the transfer of heat to the pressurized injection gas so as to elevate the temperature of the injection gas. A combustion process is generated within system 101 that creates heat. The heat is captured or handled in such a way as to interact with the injection gas in exchanger 107. Exchanger 107 is designed such that the injection gas avoids interaction with the exhaust gas of the combustion process. Exchanger 107 may be one of many different types of suitable exchangers, such as a pipe exchanger for example. Exchanger 107 is not limited to parallel flow, counter flow, or cross-flow configurations. By adjusting the combustion process, the level of heat generated may be regulated which in turn affects the temperature of the injection gas. System 101 is configured to permit an operator control so as to dictate the temperature of the injection gas prior to passing within well 117. The injection temperature of the injection gas is ideally at or above over 1000 degrees Fahrenheit.

The combustion process is regulated by the interaction between burner 113 and a fuel source 115. Naturally, burner 113 may be any type of device that allows for the burning of fuel. They type of fuel is not restricted to any particular type. Fuels which are clean burning or safest for the environment are preferred, but are in no way meant to be restricting.

The operation of the combustion process and the interaction of fuel 115 and burner 113 are regulated by electronic controller 111. Controller 111 is configured to be in electronic communication with one or more components within system 101. For example, controller 111 is in communication with burner 113 so as to be able to monitor the performance of the combustion process. Through controller 111, the amount of heat produced may be regulated. This can be done by affecting the air supplied to burner 113 and fuel 115, the flow rate and volume of fuel burned, and the overall amount of heat produced. Controller 111 is set up to regulate and monitor the temperature, pressure, and flow rate of injection gas 104.

Controller 111 is configured for the remote sensing of pressures, temperatures, and flow rates of injection gas 104. One or more sensors may be located in compressor 105, sieve 103, and exchanger 107 to monitor such levels. Controller 111 is configured to receive and transmit selected data between each component and corresponding sensors. It is known that over time, levels may fluctuate with natural fluctuations of machinery and environmental conditions. By monitoring the pressures, temperatures, and flow rates of injection gas 104, controller 111 is able to make adjustments to each component to ensure a proper temperature, pressure and flow rate of injection gas 104 entering well 117.

One such sensor is a temperature sensor 109. Sensor 109 is located between exchanger 107 and well 117. It relays data to controller 111 regarding the temperature of injection gas 104 in real time. The time intervals of readings may be set by the operator. Sensor 109 may be thermostatically controlled at the well entry point of well 117.

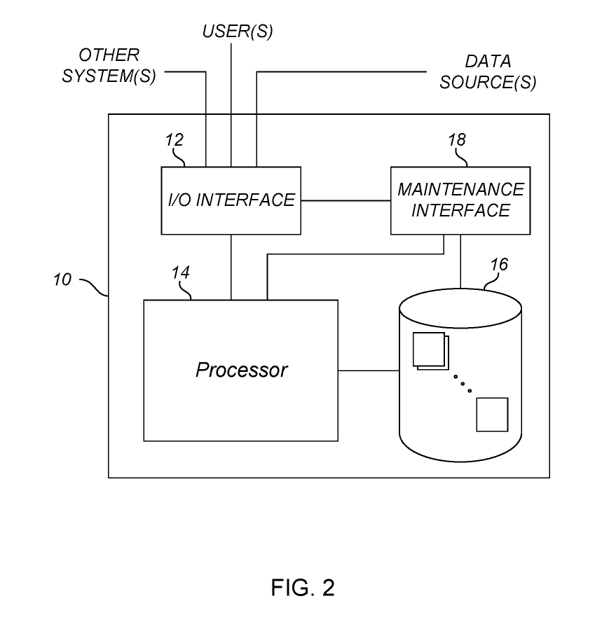

Referring now also to FIG. 2 in the drawings, an exemplary schematic of electronic controller 111 is illustrated. The system 101 includes controller 111 and any number of other electronic devices and sensors used to regulate and monitor the performance of each component in system 101 and the resultant conditions of injection gas 104. The embodiment of FIG. 2 is representative of any of these electronic devices, including controller 111. Communication between electronic devices in system 101 may be done through wired or wireless methods commonly known in the art. Through controller 111 it is conceived that an operator may regulate and monitor the operations and conditions of system 101 from a remote location.

FIG. 2 illustrates exemplary electronic device(s) 10 used for monitoring and regulating the performance of system 101 and injection gas 104. The electronic device 10 includes an input/output (I/O) interface 12, a processor 14, a database 16, and a maintenance interface 18. Alternative embodiments can combine or distribute the input/output (I/O) interface 12, processor 14, database 16, and maintenance interface 18 as desired. Embodiments of the electronic device 10 can include one or more computers that include one or more processors and memories configured for performing tasks described herein below. This can include, for example, a computer having a central processing unit (CPU) and non-volatile memory that stores software instructions for instructing the CPU to perform at least some of the tasks described herein. This can also include, for example, two or more computers that are in communication via a computer network, where one or more of the computers includes a CPU and non-volatile memory, and one or more of the computer's non-volatile memory stores software instructions for instructing any of the CPU(s) to perform any of the tasks described herein. Thus, while the exemplary embodiment is described in terms of a discrete machine, it should be appreciated that this description is non-limiting, and that the present description applies equally to numerous other arrangements involving one or more machines performing tasks distributed in any way among the one or more machines. It should also be appreciated that such machines need not be dedicated to performing tasks described herein, but instead can be multi-purpose machines, for example computer workstations, that are suitable for also performing other tasks. Furthermore the computers may use transitory and non-transitory forms of computer-readable media. Non-transitory computer-readable media is to be interpreted to comprise all computer-readable media, with the sole exception of being a transitory, propagating signal.

The I/O interface 12 provides a communication link between external users, systems, and data sources and components of the electronic device 10. The I/O interface 12 can be configured for allowing one or more users to input information to the electronic device 10 via any known input device. Examples can include a keyboard, mouse, touch screen, microphone, and/or any other desired input device. The I/O interface 12 can be configured for allowing one or more users to receive information output from the electronic device 10 via any known output device. Examples can include a display monitor, a printer, a speaker, and/or any other desired output device. The I/O interface 12 can be configured for allowing other systems to communicate with the electronic device 10. For example, the I/O interface 12 can allow one or more remote computer(s) to access information, input information, and/or remotely instruct the electronic device 10 to perform one or more of the tasks described herein. The I/O interface 12 can be configured for allowing communication with one or more remote data sources. For example, the I/O interface 12 can allow one or more remote data source(s) to access information, input information, and/or remotely instruct the electronic device 10 to perform one or more of the tasks described herein.

The database 16 provides persistent data storage for electronic device 10. While the term “database” is primarily used, a memory or other suitable data storage arrangement may provide the functionality of the database 16. In alternative embodiments, the database 16 can be integral to or separate from the electronic device 10 and can operate on one or more computers. The database 16 preferably provides non-volatile data storage for any information suitable to support the operation of the electronic device 10, including various types of data discussed herein.

The maintenance interface 18 is configured to allow users to maintain desired operation of the electronic device 10. In some embodiments, the maintenance interface 18 can be configured to allow for reviewing and/or revising the data stored in the database 16 and/or performing any suitable administrative tasks commonly associated with database management. This can include, for example, updating database management software, revising security settings, and/or performing data backup operations. In some embodiments, the maintenance interface 18 can be configured to allow for maintenance of the processor 14 and/or the I/O interface 12. This can include, for example, software updates and/or administrative tasks such as security management and/or adjustment of certain tolerance settings.

The processor 14 is configured for regulating the interaction of the various components within electronic device 10. The processor 14 may process and capture performance related information within system 101 and about injection gas 104 and automatically perform selected tasks to track and coordinate needed adjustments. The processor 14 is configured to regulate and handle the operation of electronic device 10. The processor 14 can include various combinations of one or more processors, memories, and software components.

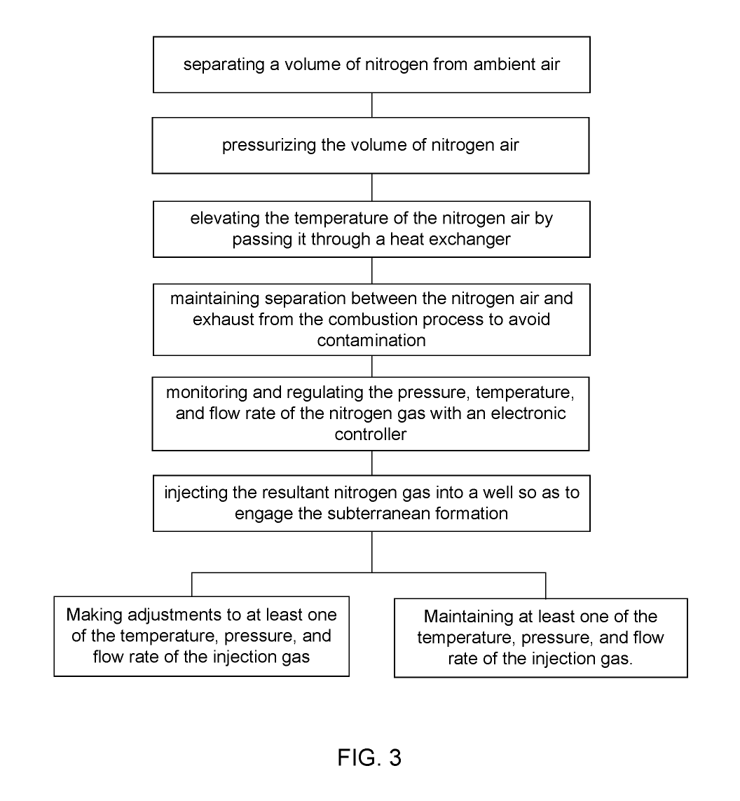

Referring now also to FIG. 3 in the drawings, a chart showing the method of injecting gas into wells with system 101 is illustrated. The method includes separating a volume of nitrogen from the ambient air to form the injection gas. The injection gas is pressurized through one or more compressors to a predetermined level. The temperature of the injection gas is then elevated by passing the injection gas through a heat exchanger. The heat is produced through a combustion process. The exhaust from the combustion process and the injection gas are prevented from mixing such that separation between the injection gas and exhaust are maintained to avoid contamination. The electronic controller monitors and regulates the pressure, temperature, and flow rate of the injection gas. The injection gas is then injected into the well so as to engage the subterranean formation. Through proper monitoring, system 101 may precisely maintain and/or adequately make adjustments to each component to affect pressure levels, the combustion process, temperature levels of the injection gas, and flow rate of the injection gas.

The current application has many advantages over the prior art including at least the following: (1) Combustion chamber design is unique due to the high volume and pressure of 2500-3500 psi; (2) Catalytic Converter design is unique for the same reasons; (3) Injection temperature over 1000° F.; (4) Volumes of 20,000 CFM to 30,000 CFM; (5) Remote sensing of pressures, temperatures and flow rates; (6) Temperature thermostatically controlled at well entry point; and (7) Volume and pressure controlled by a variable speed drive compressor.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A system for recovery hydrocarbons from a subterranean formation, comprising:
a molecular sieve configured to separate nitrogen gas from ambient air;
a compressor configured to receive the nitrogen gas from the molecular sieve and subject it to a set pressure;
a heat exchanger in communication with the compressor to receive the pressurized nitrogen gas, the heat exchanger configured to permit the transfer of heat to the pressurized nitrogen gas, the pressurized nitrogen gas being heated to a set temperature; and
an electronic controller in communication with the nitrogen gas prior to insertion into a well, the electronic controller configured to monitor and regulate the temperature, pressure, and flow rate of the nitrogen gas;
wherein the nitrogen gas is sent into the well for removal of hydrocarbons from the subterranean formation.

2. The system of claim 1, wherein the compressor is a variable speed compressor operable at a plurality of different speeds.

3. The system of claim 1, further comprising:
a thermostat in communication with the nitrogen gas after the heat exchanger, the thermostat capturing the temperature levels of the gas.

4. The system of claim 3, wherein the temperature is thermostatically controlled at an entry point of the well.

5. The system of claim 1, wherein the electronic controller is in communication with the compressor to selectively adjust the pressure level of the gas.

6. The system of claim 1, wherein the electronic controller is configured for wired and wireless communications.

7. The system of claim 1, wherein the electronic controller is configured to permit remote monitoring and remote operational control by an operator.

8. The system of claim 1, wherein the injection temperature of the nitrogen gas is over 1000 degrees Fahrenheit.

9. The system of claim 1, wherein the pressure of the nitrogen gas is between 2500 psi and 3500 psi.

10. The system of claim 1, wherein the flow rate of the nitrogen gas into the well is between 20,000 CFM and 30,000 CFM.

11. A method of recovering hydrocarbons from a subterranean formation, comprising:
separating a volume of nitrogen from ambient air;
pressurizing the volume of nitrogen air;
elevating the temperature of the nitrogen air by passing it through a heat exchanger, heat being produced through a combustion process;
maintaining separation between the nitrogen air and exhaust from the combustion process to avoid contamination;
monitoring and regulating the pressure, temperature, and flow rate of the nitrogen gas with an electronic controller; and
injecting the resultant nitrogen gas into a well so as to engage the subterranean formation.

12. The method of claim 11, wherein the pressurization of the nitrogen gas is done through a variable speed compressor, the compressor being operable at a plurality of different speeds.

13. The method of claim 11, wherein the temperature of the nitrogen gas is thermostatically controlled at an entry point of the well.

14. The method of claim 11, further comprising:
adjusting the pressure of the nitrogen gas.

15. The method of claim 11, further comprising:
regulating the amount of heat generated through the combustion process.

16. The method of claim 11, further comprising:
regulating the flow rate of the nitrogen gas into the well.

17. The method of claim 11, further comprising:
adjusting at least one of the pressure, the temperature, and the flow rate of the nitrogen gas remotely from the electronic controller.

18. The method of claim 11, further comprising:
maintaining the injection temperature of the nitrogen gas above 1000 degrees Fahrenheit.

19. The method of claim 11, further comprising:
maintaining the pressure of the nitrogen gas between 2500 psi and 3500 psi.

20. The method of claim 11, further comprising:
maintaining a flow rate of the nitrogen gas into the well between 20,000 CFM and 30,000 CFM.
